(19) United States
(12) Patent Application Publication
(10) Pub. No.: US 2012/0207570 A1
(43) Pub. Date: Aug. 16, 2012

(54) Automatic Apparatus for Feeding and Measuring Radioactive Medicine

(75) Inventors: Chia-Jung Chang, Taoyuan County (TW); Chung-Li Chen, Taoyuan County (TW); Mei-Hsiu Liao, Taoyuan County (TW); Lie-Hang Shen, Taoyuan County (TW)

(73) Assignee: ATOMIC ENERGY COUNCIL-INSTITUTE OF NUCLEAR ENERGY RESEARCH, Taoyuan County (TW)

(21) Appl. No.: 13/028,085

(22) Filed: Feb. 15, 2011

(51) Int. Cl. B65G 1/00

(52) U.S. Cl. 414/331.04

(57) ABSTRACT

Disclosed is an automatic apparatus for feeding and measuring radioactive medicine. The automatic apparatus includes a base, two elevators, two clamping units, a translation unit, a limiting unit, and a holder. The first elevator is movably supported on the base. The first clamping unit includes a sliding block movably supported on the first elevator, a shaft rotationally connected to the sliding block, and a quick-release clamp connected to the shaft. The translation unit is located on the base. The second elevator is movably supported on the translation unit. The second clamping unit includes a sliding block movably supported on the second elevator, a shaft connected to the sliding block thereof, and a pneumatic clamp connected to the shaft thereof. The limiting unit is connected to the second elevator and operable for limiting downward movement of the second elevator. The holder is located on the base.

### BACKGROUND OF THE PRESENT DISCLOSURE

1. Technical Field

The present disclosure relates to an apparatus for feeding and measuring radioactive medicine and, more particularly, to an automatic apparatus for feeding and measuring radioactive medicine.

2. Related Prior Art

A typical process for making radioactive medicine generally includes two steps. At first, an operator manually operates a clamp to clamp a bottle and move the bottle to an activity measurement device in which activity measurement can be executed. The bottle may be a labeled reaction bottle, a final product collection bottle or an aseptic vacuum bottle. Secondly, the operator manually inserts a needle already connected to an aseptic filtering film into the bottle to feed the radioactive medicine into the bottle from the needle. Then, the operator pulls the needle from the bottle. Activity measurement is executed. If the activity is below a standard, the feeding and activity measurement are repeated so that the activity of the radioactive medicine in the bottle reaches the standard. The repeated manual feeding and activity measurement exposes operators to higher doses of radiation. There are risks of contamination in the handling of the aseptic vacuum bottle, the aseptic filtering film and the needle.

The present disclosure is therefore intended to obviate or at least alleviate the problems encountered in prior art.

### SUMMARY OF THE PRESENT DISCLOSURE

It is an objective of the present disclosure to provide an automatic apparatus for feeding and measuring radioactive medicine safely.

It is another objective of the present disclosure to provide an automatic apparatus for feeding and measuring radioactive medicine precisely.

To achieve the foregoing objectives, the automatic apparatus includes a base, two elevators, two clamping units, a translation unit, a limiting unit, and a holder. The base includes an aperture defined therein, a first groove defined therein, and a second groove defined therein. The first elevator is supported on a sliding board movably located in the first groove defined in the base. The first clamping unit includes a sliding block movably supported on the first elevator, a shaft rotationally connected to the sliding block, and a quick-release clamp connected to the shaft. The translation unit is supported on two supportive elements located in the first and second grooves respectively. The second elevator is movably supported on the translation unit. The second clamping unit includes a sliding block movably supported on the second elevator, a shaft connected to the sliding block thereof, and a pneumatic clamp connected to the shaft thereof. The limiting unit is connected to the second elevator and operable for limiting downward movement of the second elevator. The holder is located on the base, with an axis of the holder extending parallel to an axis of the aperture.

Other objectives, advantages and features of the present disclosure will be apparent from the following description referring to the attached drawings.

### BRIEF DESCRIPTION OF THE DRAWINGS

The present disclosure will be described via detailed illustration of the preferred embodiment referring to the drawings wherein:

FIG. 1 is a perspective view of an automatic apparatus for feeding and measuring radioactive medicine according to the preferred embodiment of the present disclosure;

FIG. 2 is a left side view of the automatic apparatus shown in FIG. 1;

FIG. 3 is a front side view of the automatic apparatus shown in FIG. 1;

FIG. 4 is a rear side view of the automatic apparatus shown in FIG. 1; and

FIG. 5 is a top side view of the automatic apparatus shown in FIG. 1.

### DETAILED DESCRIPTION OF THE PREFERRED EMBODIMENT

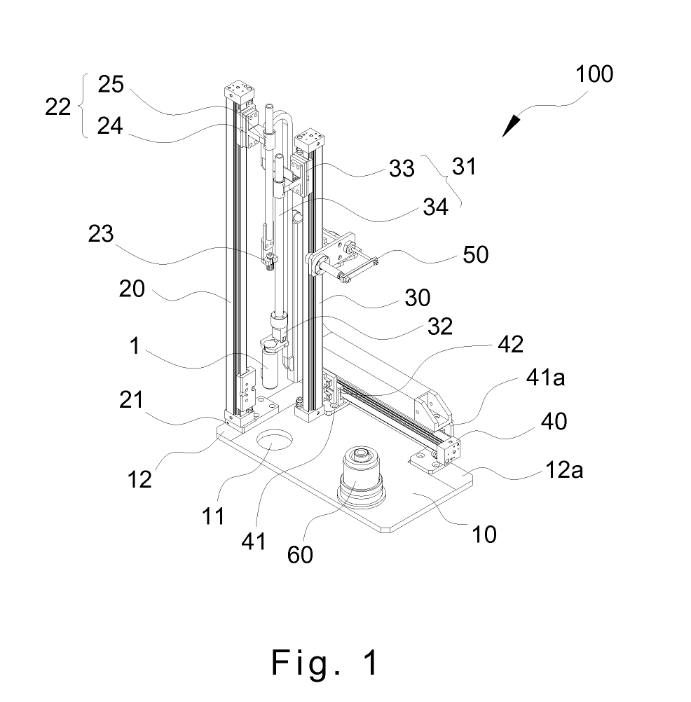

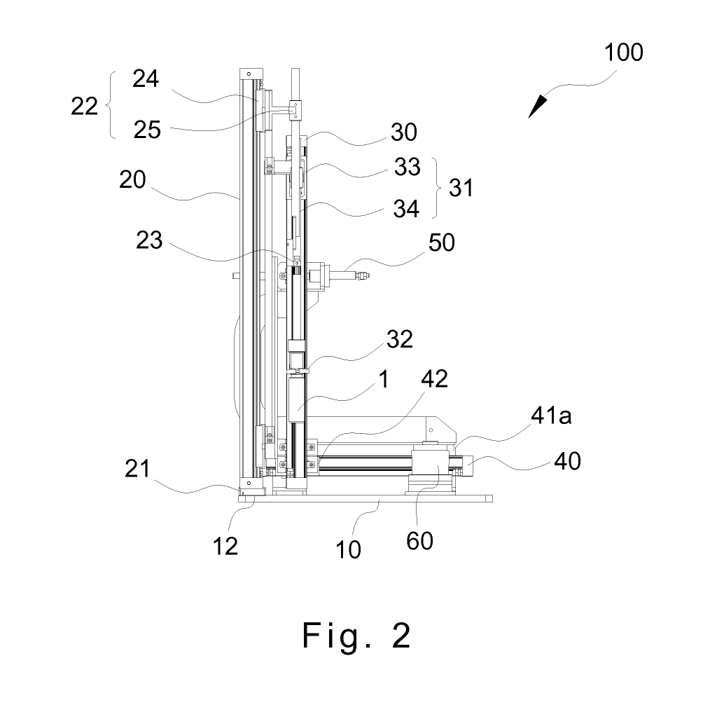

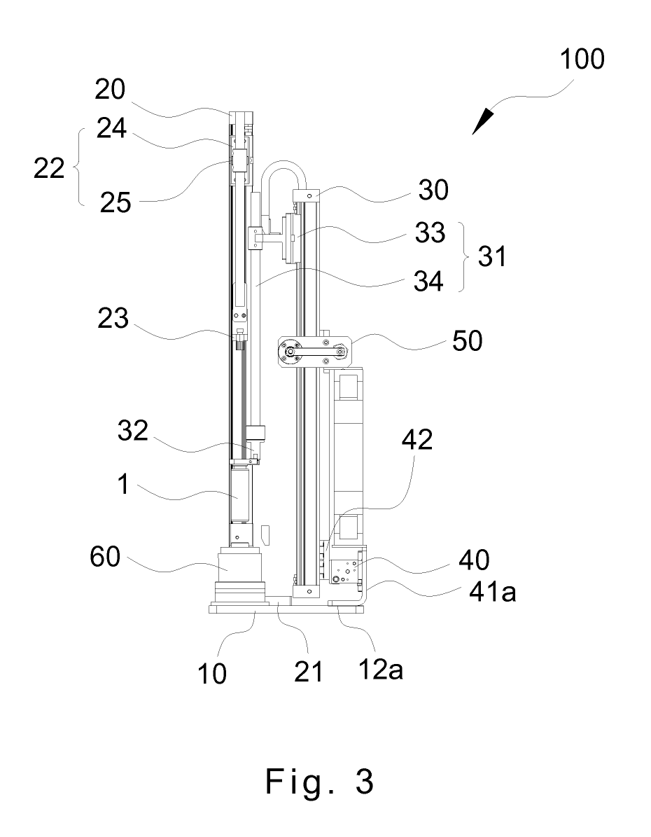

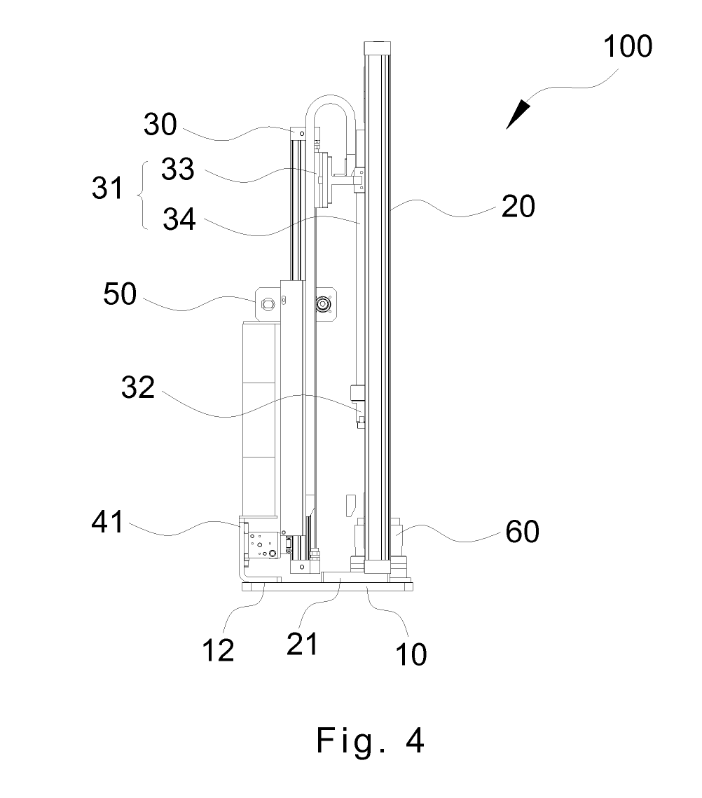

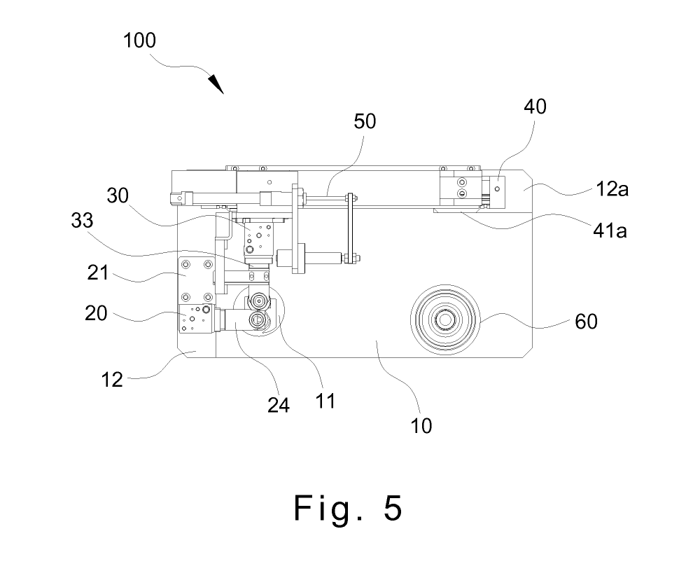

FIGS. 1 to 5 show an automatic apparatus 100 for feeding and measuring radioactive medicine according to the preferred embodiment of the present disclosure. The automatic apparatus 100 includes a base 10, a first elevator 20, a second elevator 30, a translation unit 40, a limiting unit 50 and a holder 60.

The base 10 is substantially a rectangular plate with an aperture 11 defined therein and two grooves 12 and 12a defined therein along two adjacent edges. The groove 12 extends throughout the related edge of the base 10. A needle and a medicine bottle 1, an aseptic bottle, can be passed through the aperture 11 so that injection of radioactive medicine into the medicine bottle 1 from the needle can be executed. Moreover, through the aperture 11, the needle and the medicine bottle 1 can be inserted into an activity measurement device in which activity measurement can be executed.

The first elevator 20 is a vertically extending rod-less pneumatic cylinder. The first elevator 20 includes a lower end connected to a sliding board 21 movably located in the groove 12. The first elevator 20 is operable to move a first clamping unit 22 up and down. The first clamping unit 22 includes a sliding block 24 movably supported on the first elevator 20, a shaft 25 rotationally connected to the sliding block 24, and a quick-release clamp 23 connected to the shaft 25. Thus, the quick-release clamp 23 can be moved up and down and rotated about a vertical axis to facilitate connection of an aseptic filtering film to the needle and connection of a pipe to a pipette for the injection of the radioactive medicine into the medicine bottle 1. Moreover, the first elevator 20 can removed, thus avoiding interference of the activity measurement by residual radioactive medicine in the aseptic filtering film, the needle and the pipe. Thus, the precision of the activity measurement of the radioactive medicine in the aseptic vacuum bottle can be guaranteed.

The second elevator 30 is also a vertically extending rod-less pneumatic cylinder. The second elevator 30 is used to move a second clamping unit 31 up and down. The second clamping unit 31 includes a sliding block 33 movably supported on the second elevator 30, a shaft 34 connected to the sliding block 33, and a pneumatic clamp 32 connected to the shaft 34. The pneumatic clamp 32 is used to clamp the medicine bottle 1.

The translation unit 40 is a horizontally extending rod-less pneumatic cylinder supported on the base 10. An end of the translation unit 40 is supported on an L-shaped supportive element 41 located in the groove 12. Another end of the translation unit 40 is supported on another L-shaped supportive element 41a located in the groove 12a. The second elevator 30 is movably supported on the translation unit 40 through a sliding block 42.

The limiting unit 50 is supported on the second elevator 30. The limiting unit 50 is operated between an extended position and a withdrawn position. In the extended position, the limiting unit 50 limits the vertical movement of the second elevator 30 in a desired range. In the withdrawn position, the limiting unit 50 stops limiting the vertical movement of the second elevator 30.

The holder 60 is supported on the base 10. The axis of the holder 60 is parallel to that of the aperture 11. The holder 60 is used to position the medicine bottle 1. The size of the holder 60 can be changed based on the size of the medicine bottle 1 and the size of a radiation-shielding container.

In the automatic apparatus 100, the first and second elevators 20 and 30 are used to execute vertical movement while the translation unit 40 is used to execute horizontal movement. The pneumatic clamp 32 is used to clamp. A pressure-controlling module, a pressure-sensing and regulating module and a programmable interface can be used to facilitate the automation of the automatic apparatus 100. In use, the handling of the medicine bottle 1, the needle, the pipette for feeding of the radioactive medicine into the aseptic vacuum bottle and for measuring the activity of the radioactive medicine in the aseptic vacuum bottle is done automatically. Moreover, with the automatic apparatus 100, the activity measurement and hence the feeding are precise.

The automatic apparatus 100 is operated in two modes. In the first mode, the automatic apparatus 100 only executes measurement. In the second mode, the automatic apparatus 100 executes both measurement and feeding.

In the first mode, a medicine bottle 1 is manually inserted in the holder 60. The medicine bottle 1 may be located in a radiation-shielding container before it is inserted in the holder 60. The translation unit 40 moves the second elevator 30 to a position above the holder 60 before the second elevator 30 moves downward. The limiting unit 50 extends to limit the downward movement of the second elevator 30. The pneumatic clamp 32 clamps the medicine bottle 1. Then, the second elevator 30 moves upward before the translation unit 40 moves the second elevator 30 to a position above the aperture 11. The limiting unit 50 withdraws before the second elevator 30 moves downward. Thus, activity measurement of the radioactive medicine contained in the medicine bottle 1 can be done. Then, the second elevator 30 moves upward. The translation unit 40 moves the second elevator 30 back to the position above the holder 60 before the second elevator 30 moves downward. The limiting unit 50 extends to limit the downward movement of the second elevator 30. The pneumatic clamp 32 releases the medicine bottle 1. Therefore, the medicine bottle 1 is inserted in the holder 60 again. The second elevator 30 moves upward back to the original position. The limiting unit 50 withdraws.

In the second mode, when the automatic apparatus 100 is turned off or supply of pressurized air is stopped, the first elevator 20 is manually moved, and the shaft 25 is manually rotated about the vertical axis so that the quick-release clamp 23 is located in a position where it can easily be operated to clamp a needle and an aseptic filtering film. The shaft 25 is returned to the original position before the automatic apparatus 100 is turned or the supply of the pressurized air is started. The medicine bottle 1 is manually inserted in the holder 60. The translation unit 40 moves the second elevator 30 to the position above the holder 60 before the second elevator 30 moves downward. The limiting unit 50 extends to limit the downward movement of the second elevator 30. The pneumatic clamp 32 clamps the medicine bottle 1. The second elevator 30 moves upward before the translation unit 40 moves the second elevator 30 to the position above the aperture 11. The limiting unit 50 withdraws before the second elevator 30 moves downward. Then, the first elevator 20 moves downward and inserts the needle into the medicine bottle 1 so that radioactive medicine is fed into the medicine bottle 1 from the needle through the aseptic filtering film. The first elevator 20 moves upward to facilitate activity measurement. If the amount of the radioactive medicine in the medicine bottle 1 is inadequate, the first elevator 20 will move downward and inert the needle into the medicine bottle 1 again so that more radioactive medicine can be fed into the medicine bottle 1. Then, the first elevator 20 will move upward again to facilitate one more round of activity measurement. The feeding and activity measurement might be repeated so that a desired amount of radioactive medicine is filled in the medicine bottle 1. Then, the second elevator 30 moves upward. The translation unit 40 moves the second elevator 30 back to the position above the holder 60 before the second elevator 30 moves downward. The limiting unit 50 extends to limit the downward movement of the second elevator 30. The pneumatic clamp 32 releases the medicine bottle 1. Therefore, the medicine bottle 1 is inserted in the holder 60 again. The second elevator 30 moves upward back to the original position. The limiting unit 50 withdraws.

As discussed above, with the automatic apparatus 100, the feeding and activity measurement of the radioactive medicine are executed automatically. The feeding and activity measurement can be repeated so that a precisely desired amount of radioactive medicine is filled in the medicine bottle 1.

The present disclosure has been described via the detailed illustration of the preferred embodiment. Those skilled in the art can derive variations from the preferred embodiment without departing from the scope of the present disclosure. Therefore, the preferred embodiment shall not limit the scope of the present disclosure defined in the claims.

1. An automatic apparatus for feeding and measuring radioactive medicine, the automatic apparatus comprising:
a base comprising an aperture defined therein, a first groove defined therein, and a second groove defined therein;
a first elevator supported on a sliding board movably located in the first groove of the base;
a first clamping unit comprising a sliding block movably supported on the first elevator, a shaft rotationally connected to the sliding block, and a quick-release clamp connected to the shaft;
a translation unit supported on a first supportive element and a second supportive element located in the second groove and the base, respectively;
a second elevator movably supported on the translation unit;
a second clamping unit comprising a sliding block movably supported on the second elevator, a shaft connected to the sliding block, and a pneumatic clamp connected to the shaft;
a limiting unit connected to the second elevator and configured to limit downward movement of the second elevator; and
a holder located on the base, an axis of the holder extending parallel to an axis of the aperture.

2. The automatic apparatus according to claim 1, wherein the first elevator and the second elevator comprise vertically extending rod-less pneumatic cylinders.

3. The automatic apparatus according to claim 1, wherein the translation unit comprises a horizontally extending rod-less pneumatic cylinder.

4. The automatic apparatus according to claim 1, wherein the quick-release clamp is rotatable with the shaft rotationally connected to the sliding block of the first clamping unit to position to facilitate clamping an aseptic filtering film, a needle, and a pipette.

5. The automatic apparatus according to claim 1, wherein the pneumatic clamp is configured to clamp a medicine bottle.

6. The automatic apparatus according to claim 5, wherein the aperture is configured such that the medicine bottle can be inserted into an activity measurement device through the aperture.

7. The automatic apparatus according to claim 1, wherein the base comprises a rectangular plate.

8. The automatic apparatus according to claim 7, wherein the first groove and the second groove extend along two adjacent edges of the base.

9. The automatic apparatus according to claim 1, wherein the first elevator is removably coupled to the base alone.
